(19) United States
(12) Patent Application Publication
(10) Pub. No.: US 2008/0069068 A1
(43) Pub. Date: Mar. 20, 2008

(54) Providing a client with wireless link quality, and network information

(75) Inventors: Frederick Dean, Sunnyvale, CA (US); Amalavoyal Chari, Sunnyvale, CA (US)

Correspondence Address: Tropos Networks, PO Box 641867, San Jose, CA, 95164-1867, US

(73) Assignee: Tropos Networks, Inc.

(21) Appl. No.: 11/522,883

(22) Filed: Sep. 18, 2006

(51) Int. Cl. H04B 7/216

(52) U.S. Cl. 370/342

(57) ABSTRACT

An apparatus and method of an access node of a mesh network providing a client with wireless link quality information is disclosed. The method includes the access node receiving a probe request from the client. The access node generates a probe response to the probe request. The probe response includes an indicator of the received signal strength of the probe request, and at least one mesh network path quality parameter.

### FIELD OF THE INVENTION

The invention relates generally to wireless communications. More particularly, the invention relates to a method and apparatus of providing a client with wireless link quality information.

### BACKGROUND OF THE INVENTION

Packet networking is a form of data communication in which data packets are routed from a source device to a destination device. Packets can be networked directly between a source node and a destination node, or the packets can be relayed through a number of intermediate nodes.

FIG. 1 shows a prior art wireless network that includes access points 120, 122, 124 wirelessly connecting a client device 150, 152, 154, 156 to a network (internet) 100 through a wired network 110. The client devices 150, 152, 154, 156 can initiate connection to an access point 120, 122, 124 by broadcasting an announcement (probe request) requesting services. Access points that receive the request for services respond (probe response), allowing the client device to select an appropriate access point.

The client devices can end up receiving many probe responses. Additionally, wireless connections are subject to environmental conditions that make the connections less reliable than wired connections. As a result, client devices may not do a very good job at selecting which access point to associate with. That is, the client device may select an access point that provides an inferior wireless connection as compared to another available access point.

The client device may base its selection to some extent upon the signal strengths of probe requests received from the access points. This strength, however, only reflects the quality of the wireless connection directed towards the client device. The strength does not necessarily provide an accurate indication of the quality of the wireless connection directed from the client device to the access point.

It is desirable to have an apparatus and method for providing client devices with wireless network link quality information that allows the client device to improve access point selections.

### SUMMARY OF THE INVENTION

One embodiment of the invention includes a method of an access node of a mesh network providing a client with wireless link quality information. The method includes the access node receiving a probe request from the client. The access node generates a probe response to the probe request. The probe response includes an indicator of the received signal strength of the probe request, and at least one mesh network path quality parameter.

Another embodiment of the invention includes a method of an access node of a mesh network providing a client with wireless link quality information. The method includes the access node receiving a probe request from the client. The access node generates a probe response to the probe request. The probe response includes a receive signal strength indicator that has been modified to reflect at least one mesh network parameter.

Another embodiment of the invention includes a method of an access point of a wireless network providing a client with wireless link quality information. The method includes the access point receiving a probe request from the client. The access point generates a probe response to the probe request. The probe response includes an indicator of the received signal strength of the probe request, and at least one wireless network quality parameter.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 shows a prior art mesh network.

FIG. 2 shows a wireless network that includes access points that provide client devices with link quality information.

FIG. 3A is a flow chart that includes steps of one example of a method of an access point of a wireless network providing a client with wireless link quality and wireless network information.

FIG. 3B is a flow chart that includes steps of another example of a method of an access point of a wireless network providing a client with wireless link quality and wireless network information.

FIG. 4 shows a wireless mesh network that includes access nodes that provide client devices with link quality and network path quality information.

FIG. 5A is a flow chart that includes steps of one example of a method of an access node of a wireless mesh network providing a client with wireless link quality and network information.

FIG. 5B is a flow chart that includes steps of another example of a method of an access node of a wireless mesh network providing a client with wireless link quality and wireless mesh network information.

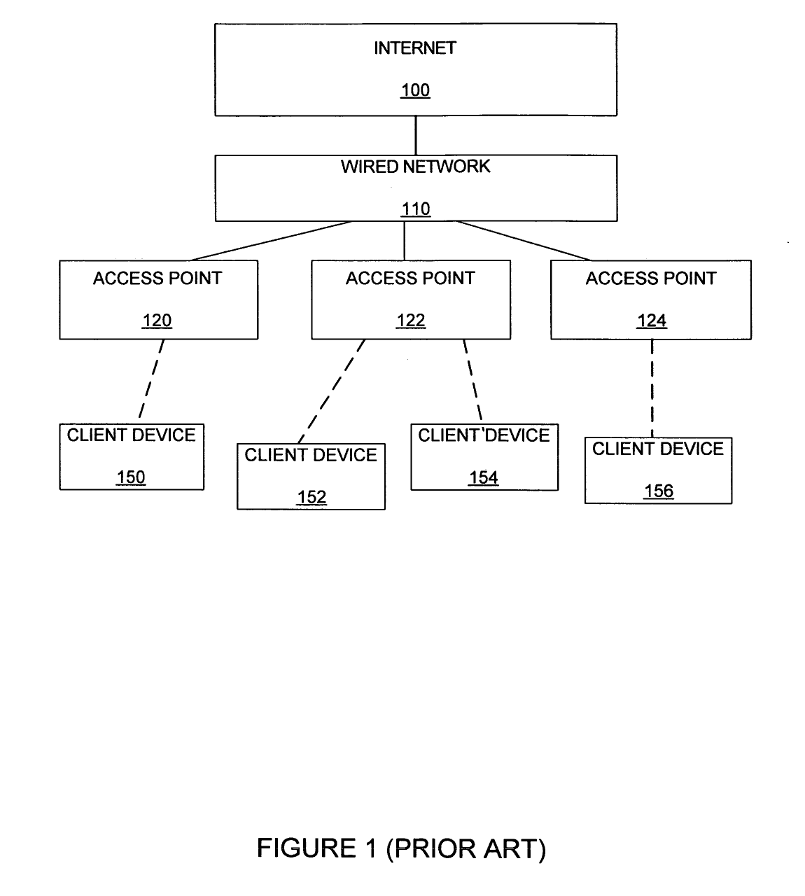

### DETAILED DESCRIPTION

As shown in the drawings for purposes of illustration, the invention is embodied in an apparatus and method for providing a client device of a wireless network with information of the quality of a link between the client device and the network, and information of at least one parameter of the wireless network. Providing the link and wireless network information allows the client device to make an intelligent decision of how (which access point, access node or gateway) to connect to the wireless network.

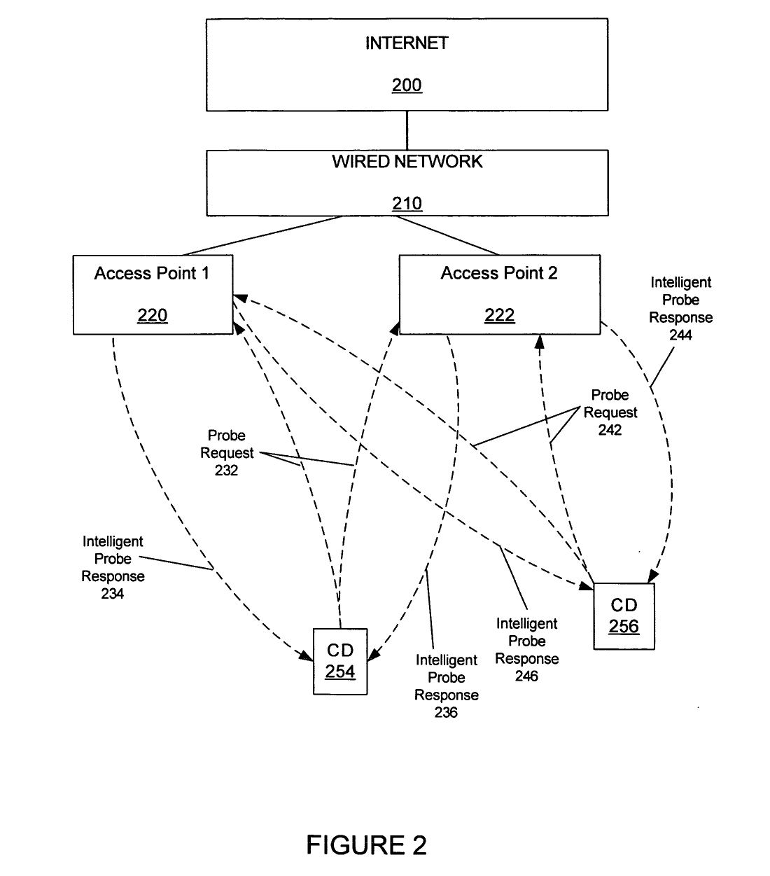

FIG. 2 shows an example of a wireless network that includes access points that provide client devices with link quality information, and information of at least one parameter of the wireless network. The wireless network includes access points 220, 222 that provide client devices 254, 256 with network connections to a wired network 210. The wired network 210 can be connected, for example, to the internet 200.

When a client device is attempting to associate with a network, the client device transmits a probe request. For example, the client device 254 transmits a probe request 232 which can be received, for example, by the access points 220, 222. In response to the probe request 232, each access point that receives the probe request 232 transmits a probe response that indicates that the access point received the probe request 232. For example, the access point 220 transmits a probe response 234, and the access point 222 transmits a probe response 236. Similarly, a second client device 256 can transmit a probe request 242. The probe request 232 can be received, for example, by the access points 220, 222, which respond with probe response 244 and 246.

Based on the probe responses 234, 236, 244, 246, the client devices 254, 256 select an access point to associate with. As previously mentioned, if the client devices receive multiple probe responses, the client devices may make a poor selection.

Intelligent Probe Responses

The probe responses 234, 236, 244, 246 include additional information that can aid the client devices 254, 256 in their selection of which access point to associate with. That is, the access points 220, 222 are configured so that the probe responses generated by the access points 220, 222 include information in addition to a standard probe response that aids the client devices in selecting an access point.

The additional information included within the probe response can be, for example, a receive signal strength of the probe requests. That is, the signal strength of the probe requests can be measured by a receiving access point. The receiving access point includes an indicator of the received signal strength indicator (RSSI) with the probe response. The client device is able thereby to gauge the quality of the link between the client device and the access point based on the RSSI. More specifically, the client device is able to gauge the quality of the link (uplink) directed from the client device to the access point. This additional link quality information can aid the client device in more properly selecting an access point.

The additional information can also include parameters of the network. Exemplary network parameters include a bandwidth of an upstream link of the access point, stability of the access point, or a latency of the access point. For the embodiment of FIG. 2, the access point are typically wire connected to a wired network, and these parameters can be, for example, stored with the access point after being determined.

The additional network information can be appended to the probe response, or the additional network information can be used to modify the previously described RSSI. That is, the quality of the RSSI influences the client device selection. The additional network parameters can influence the client device selection by modifying the RSSI depending upon the degree of desirability of the client device associating with the access point based on the network parameter.

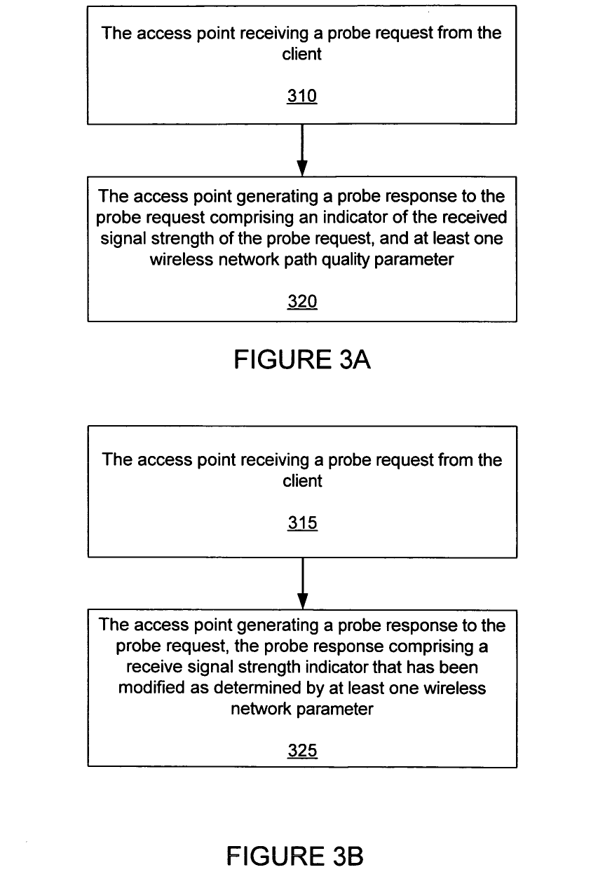

FIG. 3 is a flow chart that includes steps of one example of a method of an access point of a wireless network as shown in FIG. 2 providing a client with wireless link quality and network information. A first step 310 includes the access point receiving a probe request from the client. A second step 320 includes the access point generating a probe response to the probe request comprising an indicator of the received signal strength of the probe request, and at least one wireless network path quality parameter.

Wireless Network Path Quality Parameter

The probe response includes the receive signal strength indicator, but also includes a wireless network quality parameter. Exemplary embodiments of this parameter include a bandwidth of an upstream link of the access point, stability of the access point, or a latency of the access point.

FIG. 3B is a flow chart that includes steps of another example of a method of an point of a wireless network providing a client with wireless link quality and network information. A first step 315 includes the access point receiving a probe request from the client. A second step 325 includes the access point generating a probe response to the probe request, the probe response comprising a receive signal strength indicator that has been modified as determined by at least one wireless network parameter.

The essential difference between the embodiment of FIG. 3A and the embodiment of FIG. 3B, is that the embodiment of FIG. 3A provide the receive signal strength indicator (client link quality) along with at least one additional network parameter whereas the embodiment of FIG. 3B modifies the receive signal strength indicator based upon at least one network parameter. The network parameter and its quality are specifically provided for the embodiment of FIG. 3A, whereas they are implied for the embodiment of FIG. 3B.

Wireless Mesh Network

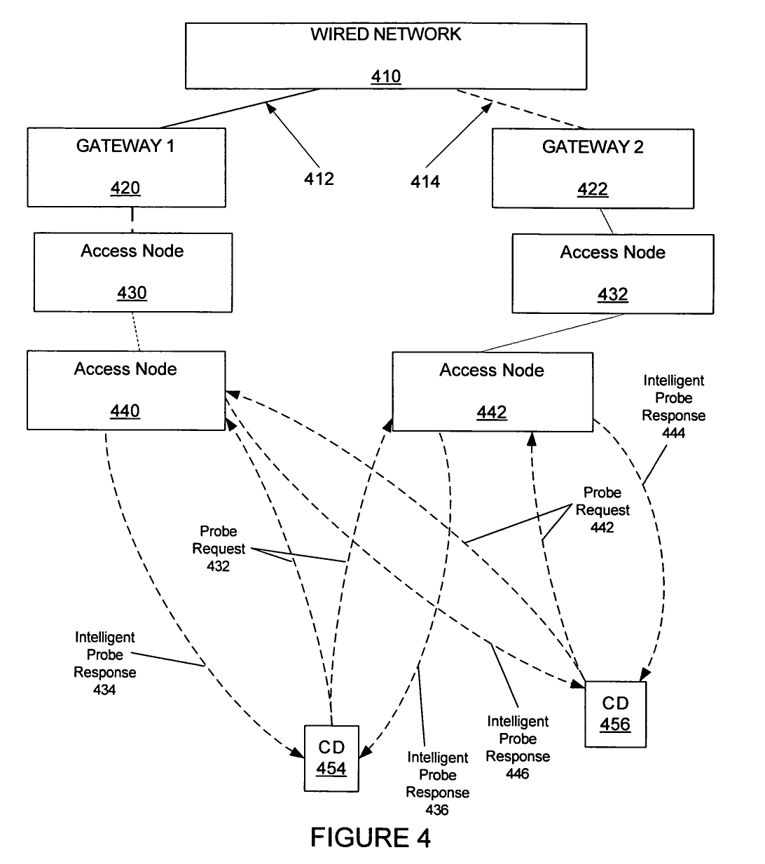

FIG. 4 shows a wireless mesh network that includes access nodes that provide client devices with link quality and network path quality information. The wireless mesh network includes gateways 420, 422 and access nodes 430, 432, 440, 442. Client devices 454, 456 can connect to a wired network 410 through the gateways 420, 422 and access nodes 430, 432, 440, 442.

The gateways 420, 422 can be wirelessly or wire connected to the wired network 410 through links 412, 414. The gateways 420, 422 can also be access nodes or access point in that the gateways 420, 422 can directly provide client devices 454, 456 with access to the wired network 410.

When the client devices 454, 456 are attempting to associate with a network, the client devices 454, 456 transmit probe requests 432, 442. All gateways and access node that receive the probe request can respond with a probe response indicating that they received the probe request, and are potential candidates for the client device to associate with. However, if the client device receives many probe responses, the client device can make a poor decision, causing the client device to associate with an inferior gateway, access node or access point.

As shown in FIG. 4, the access nodes 440, 442 each transmit probe response 434, 436, 444, 446 back to the client devices 454, 456. As indicated in FIG. 4, the probe responses 434, 436, 444, 446 include additional information to aid the client devices 454, 456 in their selection.

An embodiment of the probe response includes a quality indicator (for example, RSSI) of the link between the client device and the device transmitting the probe response. The probe response can also include at least one quality parameter of wireless network. Generally, the number of possible network quality parameters for the wireless mesh network of FIG. 4 is much greater than for the wireless network of FIG. 2.

The quality of the link can be determined, for example, by measuring the previously described received signal strength of the probe request. Wireless mesh network parameters, however, can also influence the desirability of one network device (gateways, access node or access point) over another network device. For example, data throughput, latency and stability of the device (gateway or access node) transmitting the probe response can also be useful in aiding a client device in selecting whether to associate with one device or another. The probe response of each device that receives a probe request can additionally include at least one network parameter of the device.

Mesh Network Quality Parameter

One example of a mesh network quality parameter is an indicator of a path quality of the access node to a gateway of the mesh network. As shown in FIG. 4, routing paths exist between access nodes 430, 432, 440, 442 and gateways 420, 422 of the mesh network. The quality of the paths can vary from access node to access node. The quality of the routing path can influence, for example, the data throughput and latency for data communication between the access node and the gateway. This in turn, effects the data communication of any client device 454, 456 that associates with the access node. Therefore, providing the path quality within probe responses provides the client with additional useful information that can be used to aid the client in making a selection of which probe responding device to associate with. As will be described later, the path quality can be determined during routing selections of the path through the network. The routing selections can be made by the access node based on a quality of routing paths to the gateways. The path quality can include both an upstream direction path quality (towards the default gateway) and a downstream direction path quality (away from the default gateway). A default gateway can be defined as the gateway of a previously selected routing path

Another wireless network quality parameter that can be useful includes an indicator of a bandwidth of a backhaul connection. If the connecting device is a gateway, the backhaul is the connection between the gateway and the wired network. If the connecting device is an access node, the backhaul is the connection between the default gateway of the access node and the wired network. The backhaul connections 412, 414 of the gateways 420, 422 can be wired or wireless. This information, and the bandwidth of the backhaul connections 412, 414 can be included within the probe response

Mesh networks can include fixed and mobile access nodes. Mobile access nodes are typically less reliable because of the changing condition of their wireless links (upstream and/or downstream). Therefore, another useful mesh network quality parameter is an indicator of whether the access node is a mobile access node or a fixed access node.

Mesh networks include some form of latency between, for example, an access node of the mesh network and the corresponding default gateway. More specifically, the latency can be for the data path between the access node and its default gateway. The latency can vary form one access node to another. The latency of the access node can be determined by . . . Once the access node knows its latency, it can indicate the latency through a latency indicator, which can be include as or within the mesh network quality parameter.

Routing Selections

As previously described, the quality of an upstream path from an access node to a default gateway can be determined during routing selection by the access node. An embodiment of the mesh network includes gateways originating and broadcasting routing beacons at a predetermined rate (such as 4 beacons per second). Each first level access node (such as access nodes 430, 432) receive routing beacons from at least one of the gateways. By knowing the original rate in which the beacons are broadcast from the gateways, and the rate at which routing beacons are successfully received, the receiving access node can determined the persistence of successfully received routing beacons. An embodiment includes each first level access node selecting an upstream gateway based on a persistence of successfully received routing beacons.

Each first level access node can then rebroadcast the successfully received routing beacons. The rebroadcast beacons can include additional information allowing second level access nodes that receive the rebroadcast routing beacons to determine a routing path back to a gateway. The additional information can include identification (for example, an address) of the first level access node or a hop count (hop count indicates the number of wireless links an access node is from a gateway).

The mesh network can include any number of gateways and any number of access nodes. The number of wireless hops include within the wireless mesh network is not limited.

As previously stated, the persistence of received routing beacons can be used to select a routing path to a gateway. The persistence reflects that quality of the routing path to a gateway, and can be used to provide routing path quality within probe responses transmitted by each access node.

The routing path quality can be determined in both the downstream direction (away from the default gateway) and the upstream direction (towards the default gateway). The downstream quality can be determined by receiving routing beacons as described. The upstream quality can be determined by an upstream device (access node or gateway) receiving routing beacons from the access node, determining the persistence of successfully received beacons, and then including this information in the beacons that the upstream device broadcasts, and are received by the access node.

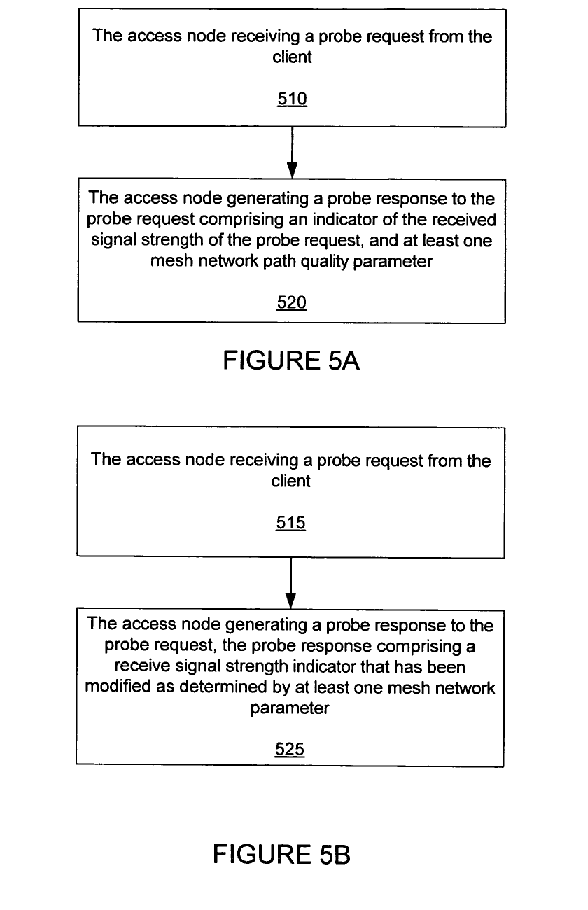

FIG. 5 is a flow chart that includes steps of one example of a method of an access node of a wireless network providing a client with wireless link quality and network information. An initial step (not shown) includes the access node selecting a routing path to a gateway of the wireless mesh network. A first step 510 includes the access node receiving a probe request from the client. A second step 520 includes the access node generating a probe response to the probe request comprising an indicator of the received signal strength of the probe request, and at least one network path quality parameter.

Wireless Mesh Network Path Quality Parameter

The probe response includes the receive signal strength indicator, but also includes a wireless mesh network quality parameter. As previously described, exemplary embodiments of this parameter include a routing path quality (downstream and/or upstream), backhaul bandwidth, latency, node type (fixed or mobile), and/or the number of wireless hops the access node is away from the default gateway. Other additional or alternate mesh networking parameters can be used as well.

FIG. 5B is a flow chart that includes steps of another example of a method of an access node of a wireless mesh network providing a client with wireless link quality and network information. A first step 515 includes the access node receiving a probe request from the client. A second step 525 includes the access node generating a probe response to the probe request, the probe response comprising a receive signal strength indicator that has been modified as determined by at least one mesh network parameter.

The essential difference between the embodiment of FIG. 5A and the embodiment of FIG. 5B, is that the embodiment of FIG. 5A provide the receive signal strength indicator (client link quality) along with at least one additional network parameter whereas the embodiment of FIG. 5B modifies the receive signal strength indicator based upon at least one wireless mesh network parameter. The wireless mesh network parameter and its quality are specifically provided for the embodiment of FIG. 5A, whereas they are implied for the embodiment of FIG. 5B.

Although specific embodiments of the invention have been described and illustrated, the invention is not to be limited to the specific forms or arrangements of parts so described and illustrated. The invention is limited only by the appended claims.

What is claimed:

1. A method of an access node of a mesh network providing a client with wireless link quality information, comprising:
the access node receiving a probe request from the client;
the access node generating a probe response to the probe request, the probe response comprising an indicator of the received signal strength of the probe request, and at least one mesh network path quality parameter.

2. The method of claim 1, wherein the mesh network quality parameter comprises an indicator of a path quality of the access node to a gateway of the mesh network.

3. The method of claim 2, wherein the path quality indicator comprises an upstream direction path quality.

4. The method of claim 2, wherein the path quality indicator comprises a downstream direction path quality.

5. The method of claim 1, wherein the mesh network quality parameter comprises a bandwidth indicator of a backhaul of a default gateway of the access node.

6. The method of claim 1, wherein the mesh network quality parameter comprises an indicator of whether the access node is a mobile access node or a fixed access node.

7. The method of claim 1, wherein the mesh network quality parameter comprises an access node latency indicator.

8. The method of claim 7, wherein the access node latency indicator provides an indication of latency of a data path between the access node and a default gateway of the access node.

9. A method of an access node of a mesh network providing a client with wireless link quality information, comprising:
the access node receiving a probe request from the client;
the access node generating a probe response to the probe request, the probe response comprising a receive signal strength indicator that has been modified to reflect at least one mesh network parameter.

10. The method of claim 9, wherein modifying the receive strength indicator as determined by at least one mesh network parameter comprises modifying an indicated strength of the probe request of the client to reflect at least one mesh network parameter.

11. The method of claim 10, wherein the mesh network quality parameter comprises and indicator of a path quality of the access node to a gateway of the mesh network.

12. The method of claim 11, wherein the path quality indicator comprises an upstream direction quality.

13. The method of claim 11, wherein the path quality indicator comprises a downstream direction quality.

14. The method of claim 10, wherein the mesh network quality parameter comprises a bandwidth indicator of a backhaul of a gateway the access node is connected to.

15. The method of claim 10, wherein the mesh network quality parameter comprises an indicator of whether the access node is a mobile access node or a fixed access node.

16. The method of claim 9, wherein the mesh network quality parameter comprises an access node latency indicator.

17. A method of an access point of a wireless network providing a client with wireless link quality information, comprising:
the access point receiving a probe request from the client;
the access point generating a probe response to the probe request comprising an indicator of the received signal strength of the probe request, and at least one wireless network quality parameter.

18. The method of claim 17, wherein the wireless network quality parameter comprises at least one of a bandwidth of an upstream link of the access point, stability of the access point, or a latency of the access point.

19. A method of an access point of a wireless network providing a client with wireless link quality information, comprising:
the access point receiving a probe request from the client;
the access point generating a probe response to the probe request, the probe response comprising a receive signal strength indicator that has been modified as determined by at least one wireless network parameter.

20. The method of claim 19, wherein the wireless network quality parameter comprises at least one of a bandwidth of an upstream link of the access point, stability of the access point, or a latency of the access point.
